(19) United States
(12) Patent Application Publication
(10) Pub. No.: US 2008/0293845 A1
(43) Pub. Date: Nov. 27, 2008

(54) Biodegradable Implant Polymers and Composites

(75) Inventor: Dong Xie, Indianapolis, IN (US)

Correspondence Address: BARNES & THORNBURG LLP, 11 SOUTH MERIDIAN, INDIANAPOLIS, IN, 46204, US

(73) Assignee: INDIANA UNIVERSITY RESEARCH AND TECHNOLOGY CORPORATION, Indianapolis, IN (US)

(21) Appl. No.: 12/095,307

(22) PCT Filed: Nov. 22, 2006
(86) PCT No.: PCT/US06/61196

§ 371 Date: May 28, 2008

Related U.S. Application Data
(60) Provisional application No. 60/740,352, filed on Nov. 29, 2005.

(51) Int. Cl. C08G 63/08

(52) U.S. Cl. 523/113; 528/361; 528/354

(57) ABSTRACT

Biodegradable oligomeric polyesters based upon hydroxy acids, such as glycolic acid (GA), lactic acid (LLA), and copolymers thereof are described. Composites that include biodegradable polyesters and bioabsorbable fillers are also described. The described polymers and composites are injectable and in situ curable.

### TECHNICAL FIELD

The invention described herein pertains to tissue implants. In particular, the invention described herein pertains to prepolymer oligomers and filled composites thereof for use in forming tissue implants.

### BACKGROUND

Synthetic biodegradable polymers with ester linkages have been widely used in biomedical and pharmaceutical applications for decades. These polymers include polyesters, polylactones, polyanhydrides, polycarbonates, poly(pseudoamino acid)s, poly(orthoester)s, polyphosphazenes, and polyphosphonates. Among them, poly(alpha-hydroxyacid) polyesters, particularly poly(glycolic acid) (PGA), poly(lactic acid) (PLA) and their copolymers are among the few biodegradable polymers with Food and Drug Administration (FDA) approval for human clinical use. Due to their biocompatibility and controlled degradability, these polyesters have been successfully used as suture materials for wound closure; drug delivery; protein delivery; cell delivery; implant devices for dental and orthopedic restorations; and tissue scaffolds for tissue engineering. Dexon (PGA) and Vicryl (P(GA-co-LLA) with the molar ratio of 90/10 are known representatives of commercially available suture products for wound healing.

Currently many applications in tissue engineering, especially in orthopedics and dentistry, require that biomaterials be shaped in situ to fit cavities and/or defects with complicated geometries in tissues. It is appreciated that such biomaterials would advantageously have low viscosities for ease of introduction, even without using co-solvents, would have high mechanical strength after curing, and would rapidly biodegrade to degradation products that are easily reabsorbed or excreted by the patient to allow replacement with endogenous tissues.

### SUMMARY OF THE INVENTION

Biocompatible tissue implants are described herein. Such tissue implants are useful in the repair or supplementation of tissue in a patient. The implants are formed from filled or unfilled prepolymer oligomers. The prepolymer oligomers are flowable and may be introduced into tissue in need of repair or supplementation. In one embodiment, the prepolymer oligomers are liquids or flowable solids that are injectable. After introduction into tissue in need of repair or supplementation, the prepolymer oligomers may be cured in situ to form filled or unfilled polymeric tissue implants having a higher molecular weight than the prepolymer oligomer introduced. In another embodiment, the cured tissue implants exhibit physical properties matching those of the tissue in need of repair or supplementation. Illustratively, the tissue in need of repair is bone or cartilage. Accordingly, in one illustrative embodiment, the cured tissue implant exhibits high strength, high strain, and high modulus.

In another embodiment, the tissue implants described herein are biodegradable. In one aspect, the cured tissue implants are biodegradable at a rate sufficiently slow to provide initial support to the tissue in need of repair or supplementation. In another aspect, the cured tissue implants are biodegradable at a sufficient rate to allow in-growth of native tissue into the repair or supplementation site.

In another aspect, the tissue implants produce degradation products that are also biocompatible. Such degradation products are desirably either reabsorbed and utilized by the patient, or easily excreted, such as in the urine.

In another embodiment, the oligomers described herein comprise one or more polyesters. Such polyesters may be formed from any of a wide variety of hydroxy acids, and include homopolymers, copolymers, block copolymers, graft polymers, or combinations thereof. In one aspect, the polyesters are linear. In another aspect, the polyesters are branched. Illustratively, branching may be achieved by including one or more multifunctional core compounds in the polyester backbone. Such multifunctional core compounds may have three, four, five, six, or more arms for attaching or propagating oligomeric chain, such as polyesters. For example, 8-arm multifunctional core compounds are contemplated herein. In another aspect, the polyesters described herein terminate in at least one hydroxyl group.

In another embodiment, the oligomers described herein comprise one or more unsaturated carboxylic acids. The carboxylic acids react with the terminal hydroxyl groups present on the polyesters described herein. In another embodiment, compositions comprising the oligomers described herein mixed with fillers are described. The fillers include ceramics, glasses, and other inorganic particles. In another embodiment, methods for repairing or supplementing tissue are described herein.

### BRIEF DESCRIPTION OF THE DRAWINGS

FIG. 1. Scheme showing synthesis of oligomeric polyester methacrylates of an illustrative 3-arm multifunctional core

FIG. 2A. Scheme showing preparation of both cured unfilled and filled tissue implant material.

FIG. 2B. Scheme showing illustrative degradation mechanisms of both unfilled and filled tissue implant material

FIG. 3. FT-IR spectra of an illustrative 3-armed multifunctional PGALLA5050 triols (lower trace) and 3-armed multifunctional PGALLA5050 trimethacrylates (TMA) (upper trace) of trimethylolpropane.

FIG. 4. ¹H NMR spectra of an illustrative 3-armed multifunctional PGALLA5050 triols (lower trace) and 3-armed multifunctional PGALLA5050 trimethacrylates (TMA) (upper trace) of trimethylolpropane.

FIG. 5. Stress-strain curves for cured unfilled and various cured filled tissue implant materials of illustrative 3-armed multifunctional PGALLA5050 trimethacrylates.

FIG. 6A. CS, DTS, and FS of the cured unfilled tissue implant material and various cured filled tissue implant materials having different ratios of the filler β-tricalcium phosphate (β-TCP) of illustrative 3-armed multifunctional PGALLA5050 trimethacrylates; the standard deviation is shown for each bar.

FIG. 6B. CS and DTS of the cured unfilled tissue implant material and various cured filled tissue implant materials having different ratios of the filler β-tricalcium phosphate (1-TCP) of illustrative 3-armed multifunctional PGALLA5050 trimethacrylates; the standard deviation is shown for each bar.

FIG. 7. Ultimate compressive strengths of an illustrative tissue implant material prepared from 3-armed multifunctional PGALLA5050 trimethacrylates that are 50% filled as a function of degradation time; the effect of molar ratio on degradation is shown; standard deviation is shown for each data point.

FIG. 8. Ultimate compressive strengths of illustrative cured unfilled and filled tissue implant materials prepared from 3-armed multifunctional PGALLA5050 trimethacrylates as a function of degradation time; effect of filler content on degradation is shown; the standard deviation is shown for each data point.

### DETAILED DESCRIPTION

In one embodiment, prepolymer oligomers are described herein. In one aspect, the oligomers are homopolymers, copolymers, block copolymers, graft copolymers, or combinations thereof. It is to be understood, that copolymers refer to polymers prepared from one, two, three, or more different monomers, in any predetermined relative ratio. Further, block copolymers refer to polymers prepared from one or more blocks and additional monomers or other blocks, where each of the one or more blocks may itself be a homopolymer, copolymer, block copolymer, star polymers, or graft copolymer. Graft copolymers refer to covalent bonding of a grafting monomer to a polymer chain. Polymerization reactions to prepare any of the homopolymers, copolymers, block copolymers, and graft polymers contemplated herein may be performed by the processes described herein, or by any conventional processes. For example, graft copolymers may be prepared in any conventional process, such as by melt grafting and/or free-radical processes, using shear-imparting and/or fluidized bed reactors, and the like. It is to be appreciated that various levels of branching and various lengths of grafting may be obtained in such grafting processes, and that each of these may be used to prepare implant materials as described herein.

In another embodiment, the prepolymer oligomers comprise one or more polyesters. The polyesters may themselves be homopolymers, copolymers, block copolymers, star polymers, graft copolymers, or combinations thereof. The polyesters may be prepared from any number of hydroxy acid monomers. In one aspect the polyesters terminate in one or more hydroxyl groups. In another aspect, the hydroxy-substituted carboxylic acid monomers are aliphatic. In another aspect, each of the hydroxy acid monomers is independently selected from compounds of the formula

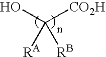

wherein n is an integer from 1 to about 11, and R^{A} and R^{B} are each independently selected from the group consisting of hydrogen, halo, alkyl, and alkoxy.

Illustrative hydroxy acid monomers include, but are not limited to, glycolic acid (GA), lactic acid (LA), including DL-lactic acid (DLLA), L-lactic acid (LLA), and D-lactic acid (DLA), β-lactones, β- and γ-butyrolactones, γ- and δ-valerolactones, ε-caprolactones, glycolide, DL-lactide, L-lactide, D-lactide, and the like. It is appreciated that the optically active forms and racemic forms of the hydroxy acids described herein may be used. For example, lactic acid may be L-lactic acid, D-lactic acid, or DL-lactic acid. It is to be understood that unless otherwise indicated, lactic acid (LA) refers individually and inclusively to both the pure enantiomers of lactic acid, racemic lactic acid, and any and all ratios of such stereoisomers of lactic acid.

In another embodiment, the prepolymer oligomers comprise one or more unsaturated carboxylic acids. In one aspect, at least one of the one or more unsaturated carboxylic acids forms an ester with at least one of the one or more terminal hydroxyl groups. In another aspect, each of these unsaturated carboxylic acids is independently selected from compounds of the formula

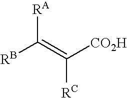

wherein R^{A}, R^{B}, and R^{B} are each independently selected from the group consisting of hydrogen, halo, alkyl, and alkoxy. Illustrative unsaturated carboxylic acids include, but are not limited to, acrylic acid, crotonic acid, methacrylic acid, and the like, each of which may be optionally substituted. In addition, optionally substituted diacids including but not limited to maleic acid, fumaric acid, and the like are contemplated herein.

It is understood that the prepolymer oligomer may have any of a variety of backbone architectures. In one embodiment, the prepolymer oligomer has a linear or substantially linear backbone. In another embodiment, the prepolymer oligomer includes one or more multifunctional core monomer components. Such multifunctional core monomers or compounds may also be referred to as multi-arm cores, star-type or star-cores, and other synonyms. Illustratively, the multifunctional core monomers include 3-armed, 4-armed, 5-armed, and 6-armed multifunctional core monomers. However, it is to be understood that the multifunctional core monomers contemplated herein may include even more arms. For example, 8-armed multifunctional core monomers are described herein. In another embodiment, the prepolymer oligomer is a graft-type copolymer.

In one aspect, 3-armed, 4-armed, 5-armed, 6-armed, and 8-armed multifunctional core monomers are described. Illustrative of such multifunctional core monomers include but are not limited to polyols such as glycerol, trimethylolethane, trimethylolpropane, pentaerythritol, dipentaerythritol, tripentaerythritol and the like.

In another embodiment, the prepolymer oligomer includes a homopolymer of glycolic acid (GA), a lactic acid (LA), or a 6-hydroxycaproic acid. In another embodiment, the prepolymer oligomer includes a copolymer, block copolymer, or graft copolymer of glycolic acid (GA) and a lactic acid (LA), such as L-lactic, D-lactic acid (DLA), and/or DL-lactic acid (DLLA). In one variation, such prepolymer oligomers include a 6-hydroxycaproic acid as a replacement or partial replacement for either the glycolic acid or lactic acid. Illustratively, a wide variation of ratios of glycolic acid to lactic acid monomers is contemplated herein, and include those ratios in the range from about 5:95 to about 95:5, or in the range from about 25:75 to about 75:25.

In another embodiment, the ratio of hydroxy acid monomer to multifunctional core molecule is in a range from about 5:1 to about 30:1 or in the range from about 5:1 to about 20:1. In one aspect, the ratio of monomer to core molecule is about 5 to 1. In another aspect, the ratio of monomer to core molecule is about 8 to 1. In another aspect, the ratio of monomer to core molecule is about 12 to 1.

It is also to be understood that the polymer implants may be prepared from any of a number of mixtures of the prepolymer oligomers described herein.

In another embodiment, compositions comprising a mixture of one or more prepolymer oligomers and one or more fillers are described herein. It is appreciated that a filler may moderate both the physical properties of the prepolymer oligomer and the cured polymeric implant. Illustratively, pure resin polymers may behave in a more plastic manner under loading, i.e., they may exhibit lower yield strength, lower modulus, and higher plastic deformation, whereas ceramics or glasses may exhibit more brittle characteristics, i.e., they may exhibit higher yield strength and higher modulus. Accordingly, it is appreciated that a filler oligomer may be included to improve or otherwise moderate the mechanical properties of the resulting cured implant. For example, increasing filler content may increase initial yield compressive strength (YCS) and/or modulus (M), but decrease ultimate compressive strength (UCS) and/or toughness (T). In one aspect, the filler may include any inorganic material, such as any salt, glass, or ceramic material. Illustratively, the filler is a phosphate salt, including a calcium phosphate salt, such as hydroxy apatite, tricalcium phosphate, β-tricalcium phosphate, bioabsorbable β-tricalciumphosphate, calcium phosphate, bioactive glass (bioglass), bioactive glass-ceramic mixtures, and/or hyaluronic acid and salts thereof.

Any of wide variety of relative percentages of filler are contemplated herein. In one aspect the relative percentage is about 20% or greater, or about 33% or greater. In another aspect, the relative percentage is about 75% or less, about 67% or less, or about 60% or less. In another aspect, the relative percentage is in the range of about 40% to about 50%.

In another embodiment, the filler is pretreated with a component that may increase its lipophilicity or decrease its hydrophilicity, such as silyloxyacrylate. Illustrative silyloxyacrylates include but are not limited to 3-(trimethoxysilyl)propyl methacrylate, 3-[tri(trimethylsilyloxy)silyl]propyl methacrylate, and the like. It is appreciated that such pretreatment may facilitate the interaction of the filler with the resin, as described in Xie, D., Chung, I-D., Wang, G., Feng, D., Mays, J., “Synthesis, formulation and evaluation of novel zinc-calcium phosphate-based adhesive resin composite cement,” Eur Polym J., 40(8):1723-1731 (2004), the disclosure of which is incorporated herein by reference.

It is further appreciated that when the tissue in need of repair is a bone or cartilage tissue, certain calcium phosphate salts are particularly suited for repairing or supplementing such bone or cartilage tissue. Illustratively, calcium phosphate salts such as hydroxy apatite and/or β-tricalciumphosphate may be osteoinductive, osteogenic, and/or osteoconductive, and therefore may promote bone or cartilage cell growth and/or bone or cartilage cell induction at the site of the defect or injury.

In another embodiment the biodegradable oligomer systems described herein can be stabilized using polymerization inhibitors. It is appreciated that the oligomers may be prepared to include the required or desired polymerization initiators in a kit fashion. In such kits, it may be desirable to increase the shelf life of the material without diminishing the curing characteristics needed for the various implant conditions described and contemplated herein. Illustrative inhibitors include hydroquinone (HQ), hydroquinone monomethyl ether (MEHQ), butylated hydroxytoluene (BHT), butylated hydroxyanisole (BHA), and the like. A wide range of concentrations are contemplated herein in order to provide stabilization under a variety of conditions. Illustrative ranges of concentrations of inhibitors used to stabilize the biodegradable oligomer systems described herein include, but are not limited to, from about 0.01% to about 5% of the liquid resin by weight, or from about 0.01% to about 1% of the liquid resin by weight. In an illustrative embodiment, MEHQ is used to stabilize the curable systems described herein. In another illustrative embodiment, MEHQ is used in a concentration range of from about 0.01 to about 0.5, from about 0.03 to about 0.25, or from about 0.05 to about 0.25 percent by weight of the liquid resin component, to stabilize the curable systems described herein.

It is further appreciated that the polymer implants may be prepared from any of a number of mixtures of the prepolymer oligomers and/or from any of a number of mixtures of the filled prepolymer oligomers described herein. Such mixtures may include different oligomer chemical compositions, different oligomer backbone architecture compositions, and the like. Such mixtures may also include different fillers.

It is further appreciated that the physical properties of the prepolymer oligomers and the mechanical properties of the cured implant materials may be modified by the nature of and/or by also the changing ratio of monomers making up the polyester. It is further appreciated that the physical properties of the prepolymer oligomers and the mechanical properties of the cured implant materials may be modified by the nature of and also the changing ratio of filler to oligomer. Illustratively, copolymers of GA and LA may generally have lower viscosities than either homopolymer. Further, increasing the GA/LA ratio may generally increase the initial compressive strength and/or the diametral tensile strength of either unfilled or filled polymer implants resulting from curing those prepolymer oligomers. It is further appreciated that such physical properties may be adjusted further for certain applications by varying the ratio of stereoisomers, or by instead employing pure enantiomers, of chiral hydroxy acids, such as lactic acids.

It is further appreciated that polymer implants described herein may be prepared by curing various mixture of the prepolymer oligomers described herein, including mixtures of various chemical compositions, mixtures of various backbone architecture, mixtures of various fillers, combinations thereof, and the like.

In one embodiment, the oligomer prepolymers are liquids or flowable solids. In another embodiment, the filled prepolymer oligomer compositions are liquids or flowable solids. The term “flowable” as used herein generally refers to the ability of a material to flow either of its own accord or under the influence of a mechanical force, such as may be illustratively exerted by the plunger element of a syringe. Compositions of paste-like or putty-like consistency as well as those of liquid or runny consistency are also properly referred to as flowable. The term also applies to compositions whose consistencies allow a shape-sustaining character, but are still readily deformable. Specific forms of flowable compositions include cakes, pastes, putties, creams, fillers, and liquids. In one aspect, the unfilled or filled oligomers are flowable and thus adapted to be shaped to fit or directly introduced in cavities, defects, and the like, any of which may have a complicated geometry.

In another embodiment, the implant materials described herein are curable in-situ. In such embodiments, it is appreciated that in situ formation of implants may provide for more extensive tissue bonding. Such tissue bonding may encourage, enhance, or promote more extensive in-growth of native or endogenous tissue into the implant material, which may in turn leads to more extensive and better-timed biodegradation, and the eventual replacement of the implant with native tissue from the patient. In another embodiment, liquid and/or flowable solid implant material described herein may be introduced directly into the repair site by any appropriate technique. In one aspect, such liquids and/or flowable solids may be introduced directly into the repair site by injection.

In another aspect, the implant materials described herein are injectable and in situ polymerizable before being cured to a solid having the mechanical properties required for the desired repair or supplementation. In another aspect, filled prepolymer oligomers containing as high as 75% filler loading are described herein. Such filled oligomers may be flowable pastes that are suitable for introduction by injection due to the low viscosities observed with such pre polymer oligomers. It is further appreciated that in this and other embodiments described herein, including a multifunctional core component may increase the spherical nature of the synthesized prepolymer oligomer, and thereby improve the flowability of the unfilled oligomer or filled oligomer composition.

It is appreciated that both the low molecular weight and the low viscosity values of the filled and unfilled prepolymer oligomers contribute to their flowability. Those properties are at least partially indicative of oligomers that are adapted for biomedical and orthopedic applications, as further defined in Tsuruta, T., Hayashi, T., Kataoka, K., Ishihara, K., Kimura, Y., “Biomedical Applications of Polymeric Materials,” Boca Raton, Fla.: CRC Press, Inc., (1993), the disclosure of which is incorporated herein by reference.

In one aspect, the implants described herein have improved mechanical strength compared to conventional implants. In another aspect, the implants have improved tissue compatibility compared to conventional implants. In another aspect, the implants have improved controllable biodegradation rates compared to conventional implants. It is appreciated that the mechanical properties of the implant are desirably similar to the tissue being repaired or supplemented. For example, implants for bone are likely to advantageously have greater compression strength and/or tensile strength, whereas implants for cartilage are likely to advantageously have greater flexibility. It is understood that depending upon the mechanical properties selected as desirable, there may be a trade off between the optima for some mechanical properties at the expense of others. The mechanical properties of the cured resins may be evaluated using standard ASTM protocols to determine for example, initial yield compressive strength (YCS), modulus (M), ultimate compressive strength (UCS), diametral tensile strength, flexural strength, and/or toughness (T), and the like. With routine experimentation, the desired physical properties of the implant material may be adjusted and modified by changing and/or combining the various embodiments and aspects described herein.

In one aspect, the cured resins described herein, and illustratively prepared from trimethylolpropane, exhibit initial yield compressive strength (YCS) in the range from about 4 MPa to about 60 MPa. In another aspect, the cured resins are unfilled resins, and exhibit initial yield YCS in the range having a lower limit of about 4 MPa, and an upper limit of about 20 to 25 MPa. In another aspect, the cured resins are filled resins, and exhibit initial yield YCS in the range having a lower limit of about 25 to 30 MPa, and an upper limit of about 50 to 60 MPa.

In another aspect, the cured resins described herein, and illustratively prepared from glycerol, exhibit initial yield YCS in the range having a lower limit less than about 40 MPa, and an upper limit greater than about 80 MPa.

In another aspect, the cured resins described herein, and illustratively prepared from trimethylolpropane, exhibit modulus (M) in the range from about 200 MPa to about 4 GPa. In another aspect, the cured resins are unfilled resins, and exhibit M in the range having a lower limit of about 200 MPa, and an upper limit of about 700 to 750 MPa. In another aspect, the cured resins are filled resins, and exhibit M in the range having a lower limit of about 1 GPa, and an upper limit of about 3 to 4 GPa.

In another aspect, the cured resins described herein, and illustratively prepared from trimethylolpropane, exhibit ultimate compressive strength (UCS) in the range from about 80 MPa to about 300 MPa. In another aspect, the cured resins are unfilled resins, and exhibit UCS in the range having a lower limit of about 80 MPa, and an upper limit of about 300 to 320 MPa. In another aspect, the cured resins are filled resins, and exhibit UCS in the range having a lower limit of about 80 MPa, and an upper limit of about 150 to 160 MPa.

In another aspect, the cured resins described herein, and illustratively prepared from glycerol, exhibit ultimate compressive strength (UCS) in the range having a lower limit of about 110 MPa, and an upper limit of about 200 MPa.

In another aspect, the cured resins described herein exhibit toughness (T) in the range from about 1 to about 4 KN·mm. In another aspect, the cured resins are unfilled resins, and exhibit T in the range from about 1 to about 4 KN·mm. In another aspect, the cured resins are filled resins, and exhibit T in the range from about 1 to about 2 KN·mm.

It is appreciated that the cured resins including a filler may have different mechanical properties, such as increased initial YCS, higher M, similar or lower UCS, and/or similar or lower T. It is also understood that the cured resins including a filler may exhibit lower variability in either UCS, or T, or both.

In one embodiment, the cured unfilled resins not including a filler exhibit initial YCS ranging from about 4 to greater than about 20 MPa, M ranging from about 200 to greater than about 730 MPa, UCS ranging from about 80 to greater than about 310 MPa, and T ranging from about 1 to about 4 KN·mm. In another embodiment, the cured resins including a filler exhibit initial YCS ranging from about 20 to about 70 MPa, M ranging from about 1 to about 4 GPa, UCS ranging from about 80 to about 160 MPa, and T ranging from less than about 1 to about 2 KN·mm.

In another embodiment, the cured resins illustratively prepared from glycerol exhibit initial YCS ranging from less than about 40 to greater than about 80 MPa, M ranging from 1.63 to 3.24 GPa, UCS ranging from about 110 to about 200 MPa. In another embodiment, the cured resins, made from GA/DLLA-based composites, exhibit initial YCS ranging from less than about 40 to greater than about 80 MPa, M ranging from about 1.5 to about 3.5 GPa, UCS ranging from about 110 to about 200 MPa.

It is appreciated that the relative ratio of various monomers may affect the physical properties of the resulting cured resins. Illustratively, increasing ratios of glycolic acid to lactic acid may generally increase the initial compressive properties of the resins, whether derived from a unfilled oligomer or a filled oligomer. It is further appreciated that the relative ratio of filler may affect the physical properties of the resulting cured resins. Illustratively, increasing filler ratio may generally increase yield strength and/or modulus. In contrast, increasing filler ratio may generally decrease ultimate strength and/or toughness. Without being bound by theory, it is suggested that these properties may be consistent with the nature of the β-TCP filler. For example, it has been reported that adding fillers to a polymer increases the brittleness of the resulting cured composite, as described in Davidson, C. L. and Mjör, I. A. “Advances in Glass-Ionomer Cements” Chicago, Quintessence Publ Co. (1999), the disclosure of which is incorporated herein by reference. In contrast, toughness is a measure of energy absorption of a material when it undergoes a stress. Toughness is expressed as the area under a stress-strain curve.

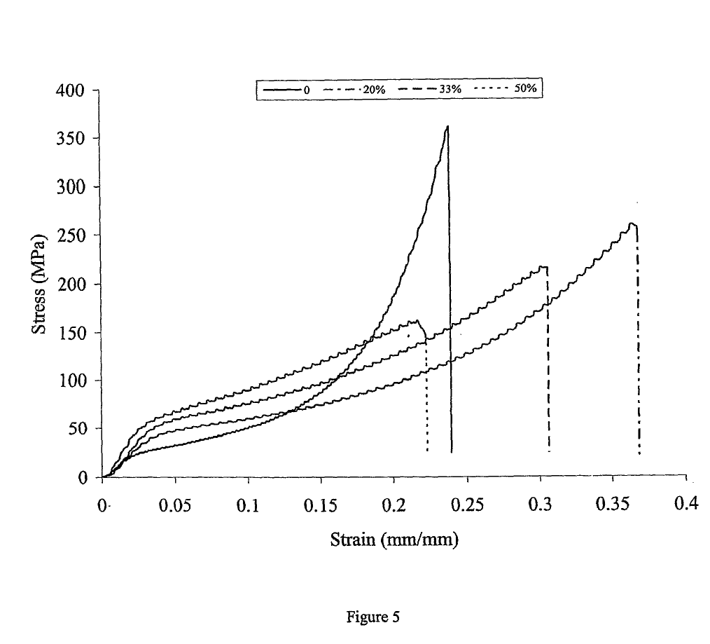

FIG. 5 shows several typical stress-strain curves corresponding to different filler ratios in a cured filled implant material. The prepolymer oligomer is illustratively prepared from trimethylolpropane and glycolic acid. It can be observed that the shape of the stress-strain curve for unfilled resin is different from the shapes for filled composites. Though the curve for the unfilled resin shows the highest ultimate strength, the yield strength was relatively low showing a strong plastic deformation. In contrast, most of the curves for the filled composites were high in yield strength, high in strain, and high in modulus.

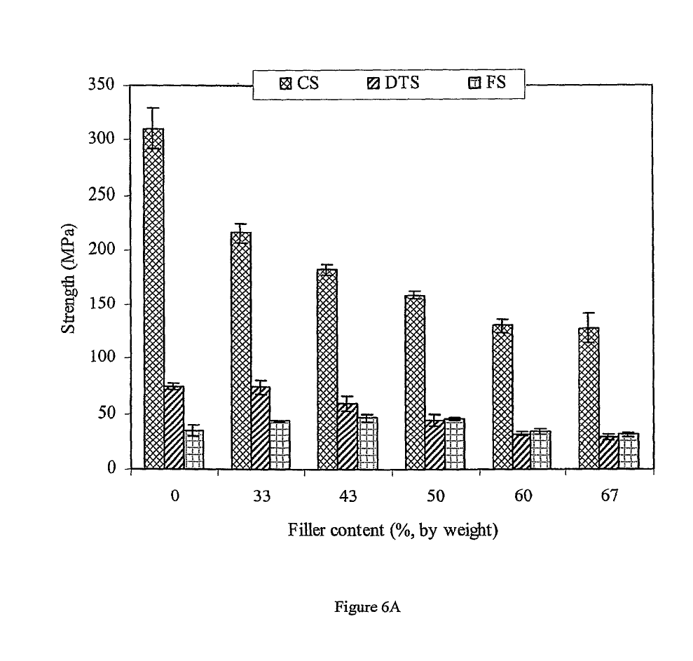

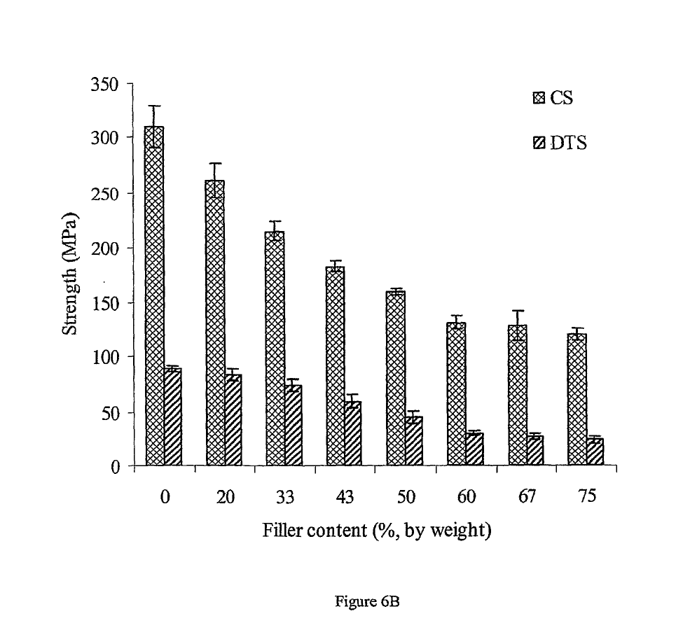

It is further appreciated that flexural strength (FS) may be optimized by appropriately selecting the relative ratio of filler to oligomer. Illustratively, for an oligomer prepared from glycolic acid, the flexural strength is highest for filler in the range from about 33% to about 50% filler, or from about 40% to about 45% filler, when the filler is β-TCP (see, FIG. 6A).

It is further appreciated that increasing the relative ratio of filler may increase the curing time, and/or decrease the degree of conversion (DC) of oligomer to cured resin. In addition, it is appreciated that increasing the relative ratio of filler may decrease any exotherm associated with the curing. It is appreciated that in certain configurations, decreases in exotherm are advantageous. High exotherm from in situ curing or polymerization may damage surrounding tissues. Such low exotherms exhibited by implant materials described may be due to both the properties and relative quantity of filler and the oligomer. It is known that ceramic or glass fillers may be considered as heat insulators. Further, oligomers described herein may have relatively fewer carbon double bonds by molecular weight as compared to for example polymers of MMA, which may be attributed to interference by the filler with the polymerization of the resin.

It is further appreciated that degradation rates of the biodegradable implants described herein may be controlled by the relative ratios of the various monomers, and/or the relative ratio of the one or more fillers. Illustratively, degradation rates may generally increase with increasing relative ratios of filler.

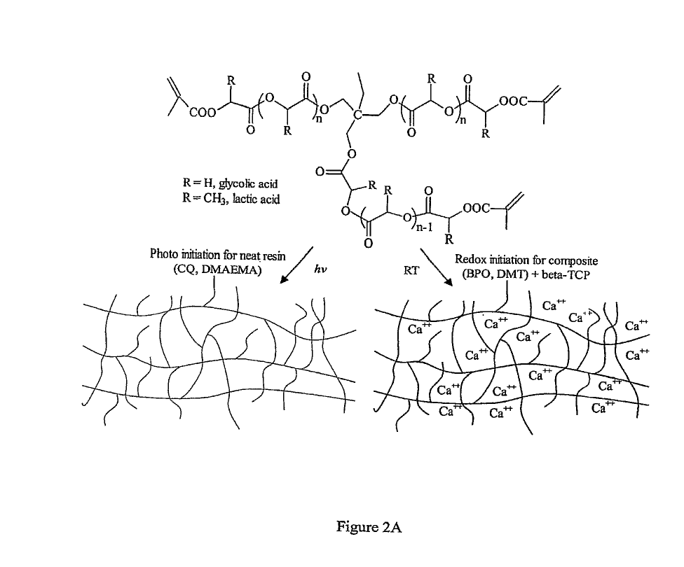

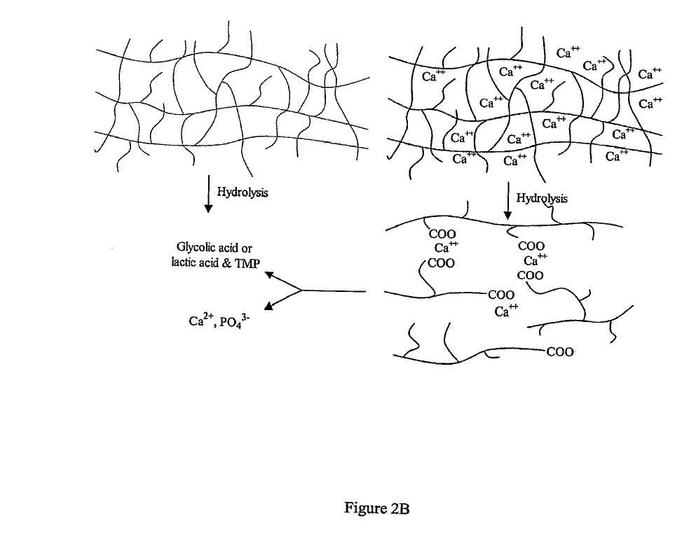

In another embodiment, the unfilled prepolymer oligomers and filled oligomer composites described herein are curable in situ. In one aspect, the oligomers and composites may be cured chemically, such as with redox-initiation systems, radical initiation systems, and the like, and combinations thereof. In another aspect, the curing may be accomplished photo chemically, such as with visible light, ultraviolet radiation, other light sources, photo initiators, photo activators, and the like, and combinations thereof. Illustrative curing processes are shown in FIG. 2A. In addition, illustrative schematics are shown for unfilled and filled cured implant material. It is to be understood that the syntheses shown in FIG. 2A are illustrative and may be generalized by the appropriate inclusion or substitution of other monomers, the introduction of alternate, additional, or the removal of multifunctional core monomers, the introduction of alternate or additional unsaturated carboxylic acids, and/or by including graft polymers as described herein.

Illustrative chemical processes include reagents, initiators, and activators. Illustrative initiators include peroxides, such as hydrogen peroxide, benzoyl peroxide (BPO) and the like, peroxy acid, and other initiators. Illustrative activators include optionally substituted anilines, such as N′,N′-dimethyl-para-toluidine (DMT), N′,N′-dimethylaniline, ascorbic acid, vitamin C, and the like.

Illustrative photo chemical processes include sources, reagents, initiators, and activators. Illustrative initiators include quinones, such as camphorquinone and optical isomers thereof, and the like. Illustrative activators include activated esters, such as activated esters of the one or more conjugated carboxylic acid monomers included in the oligomer, like 2-(dimethylamino)ethyl methacrylate, 2-(dimethylamino)ethyl acrylate, 2-(dimethylamino)ethyl crotonate, and the like. It is appreciated that the stabilization inhibitors described herein, including hydroquinone (HQ), hydroquinone monomethyl ether (MEHQ), butylated hydroxytoluene (BHT), butylated hydroxyanisole (BHA), may also operate in certain variations described herein as photoinitiators.

It is appreciated that photo-initiation may not be suitable for curing all filled prepolymer oligomers. In some embodiments, the nature of, or the relative ratio of filler material may render the filled oligomer too opaque for effective curing using photo chemical processes. Sufficient light may not be able to penetrate into thick implants to allow complete polymerization. In some embodiments, light penetration into translucent filled oligomer may be limited to only a few mm, such as about 2-3 mm. In those embodiments redox initiation may be used as described herein, and further described in Craig, R. G., “Restorative Dental Materials,” 10^{th} ed. St Louis: Mosby-Year Book, Inc. (1997).

In another aspect, the implants are cured at temperatures below the patient body temperature, or alternatively are cured at ambient temperatures. In another aspect, the implants are curable in minutes or alternatively in seconds.

As used herein, the term molecular weight may refer to either a single molecule, or to an average molecular weight exhibited by a mixture of compounds preparable herein. In one embodiment, the molecular weight is an average molecular weight of oligomers or polymers. In one aspect, the average molecular weight is based on a number average. In another aspect, the average molecular weight is based on a weight average. In another aspect, the number average molecular weight is in the range from about 100 to about 15,000 Daltons. In another aspect, the weight average molecular weight is in the range from about 200 to about 40,000 Daltons. In another aspect, the number average molecular weight is in the range from about 300 to about 500 Daltons.

In another embodiment, the viscosity of the unfilled oligomer or filled oligomer composition is low. In one aspect, the viscosity of the unfilled oligomer is less than about 1500 centipoise, or less than about 1000 centipoise, or less than about 500 centipoise, or less than about 150 centipoise, or less than about 100 centipoise.

In another embodiment, the implants described herein have controllable biodegradation rates. The biodegradation is controllable by predetermining the relative ratio of and type of hydroxyacid monomers used to prepare the polyester portion of the oligomer in the unfilled precursor oligomers described herein. In addition, the biodegradation is controllable by predetermining the percentage or ratio of filler to oligomer in the filled compositions described herein. In one aspect, the implants biodegrade by standard chemical processes present in the patient, including hydrolysis, which may be acid or base catalyzed. In another aspect, the implants biodegrade by standard biochemical or biological processes present in the patient, including by the action of cells, enzymes, and the like.

In another embodiment, additional tissue growth promoting components are added to the oligomer composition. Illustratively, the additional component is an osteogenic agent or chondrogenic agent, where the osteogenic agent or chondrogenic, such as a protein, a non-native protein, a protein fragment, or a peptide. In another embodiment, the additional component is a cell or population of cells, such as bone marrow cell, a genetically-modified cell, or a population of bone marrow cells or genetically-modified cells. In another embodiment, the additional component is an inhibitor of bone resorption, such as estrogen, selective estrogen receptor modifiers, bisphosphonates, src-tyrosine kinase inhibitors, cathepsin K inhibitors, vacuolar-ATPase inhibitors, or analogs or derivatives thereof. In other illustrative embodiments, the additional component is a bone anabolic agent, such as a statin, fluprostenol, vitamin D or analog, prostaglandin, or analogs or derivatives thereof. In other illustrative embodiments, the additional component is a bone cell stimulating factor (BCSF), growth factor, chrysalin, KRX-167, MP52, a bone morphogenetic protein, such as BMP-2, or an analog or derivative thereof.

The compositions may also include a bioactive component such as collagen, collagen lattices and insoluble collagen derivatives, radio-opacifying agents, carboxymethylcellulose, hydroxyethylcellulose, sodium alginate, and xanthan gum. Other bioactive components include analgesics, such as salicylic acid, acetaminophen, ibuprofen, naproxen, piroxicam, flurbiprofen, morphine, cocaine, lidocaine, bupivacaine, xylocaine, and benzocaine. Still other bioactive components include amino acids, peptides, vitamins, inorganic elements, co-factors for protein synthesis, hormones, enzymes, nerve growth promoting substances, fibronectin, growth hormones, colony stimulating factors, cytokines, interleukin-1, angiogenic drugs and polymeric carriers containing such drugs, biocompatible surface active agents, anti-thrombotic drugs, cytoskeletal agents, natural extracts, bioadhesives, antitumor agents, antineoplastic agents, tumor-specific antibodies conjugated to toxins, tumor necrosis factor, cellular attractants and attachment agents, immuno-suppressants, permeation and penetration enhancers, blood, blood cells, and nucleic acids. Still other bioactive components that may be included in the compositions described herein include antibiotics and/or antibacterial agents, such as for example, aminoglycosides (Neomycin, Streptomycin, Kanamycin), carbacephems (Loracarbef), carbapenems (Ertapenem), cephalosporins (Cefepime, Ceftriaxone, Cefoperazone, Cefamandole, Cefprozil, Cephalexin, Cefazolin), glycopeptides (Teicoplanin, Vancomycin), macrolides (Azithromycin, Erthyroycin, Clarithromycin), monobactams (Aztreonam), penicillins (Amoxicillin, Ampicillin, Cloxacillin, Ticarcillin), polypeptides (Bacitracin), quinolines (Ciprofloxacin, Levofloxacin, Moxifloxacin, Trovafloxacin), sulfonamides (Sulfamethizole, Trimethoprin, Trimethoprim-Sulfamethoxazole), tetracyclins (Doxycycline, Tetracycline), and others, such as Chloramphenicol, Clindamycin, Linezolid, Spectinomycin, and the like.

In another embodiment, the unfilled or filled oligomers compositions are solvent free. In another embodiment, the unfilled or filled oligomers compositions are sterilized by any conventional technique. It is appreciated that post-sterilization of embodiments described herein that include cells is not compatible. In those cases, sterilization must take place prior to the introduction of the cell component.

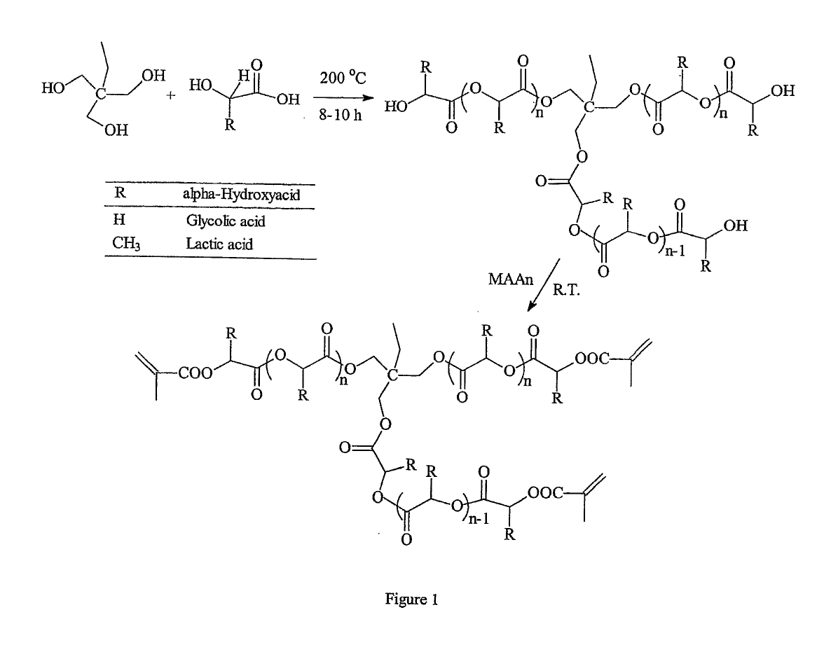

The oligomers and polyesters described herein may be prepared using conventional synthetic methods. In addition, various syntheses are described herein. FIG. 1 shows an illustrative synthesis of one embodiment of the oligomers described herein, namely where the monomers are selected from glycolic acid and lactic acid, and where an illustrative 3-armed multifunctional core is included. The monomers and the core are reacted at elevated temperatures to prepare the corresponding hydroxy-terminated oligomers. Subsequently, the hydroxy-terminated oligomers are reacted with an activated unsaturated carboxylic acid, such as acrylic or methacrylic anhydride (MAAn), acryl or methacryl chloride, acryl or methacryl triflate, 2-isocyanatoethyl acrylate or methacrylate (IEM), and the like, to form the one or more unsaturated ester termini. However, it is appreciated that the synthesis described in FIG. 1 may be adapted to prepare any of the oligomers described herein by substituting the appropriate hydroxy acid monomers, and/or activated unsaturated carboxylic acids.

Illustratively, it is understood that the group R though shown as either hydrogen or methyl in FIG. 1, may be varied to include other substituents, including halogens, alkoxy groups, alkylthio groups, longer alkyl groups, and the like, each of which may be further substituted. Further, it is understood that in each instance the multiplicity “n” of the polymer is potentially different, and may be any integer from about 1 to about 20,000. That range corresponds to an illustrative range of number molecular weights that contributes to the number average molecular weight range described herein. Therefore, the structures in FIG. 1 should be understood to include oligomeric backbones from completely random alternating oligomers, to varying degrees of block copolymer architecture.

In another embodiment, the oligomers are prepared by mixing one or more hydroxy acid monomers, homopolymers, copolymers, block copolymer, and/or graft polymers under polymerizing conditions. In one aspect, the hydroxy acid monomers are independently selected from hydroxy acids of the formula

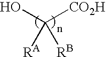

where n is an integer from 1 to about 11, and R^{A} and R^{B} are hydrogen, or each are an independently selected substituent, such as halo, alkyl, alkoxy, and the like. In embodiments that include a multifunctional core, such as a 3-armed star, 4-armed star, 5-armed star, 6-armed star, or even 8-armed core, the multifunctional core is included in the polymerization reaction to form the polyester.

In another embodiment, the oligomers are prepared by mixing one or more lactone monomers under ring-opening polymerizing conditions with one or more. In one aspect, the lactone monomers are independently selected from compounds of the formulae

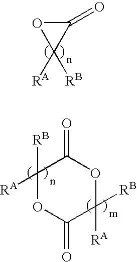

where n and m are independently selected integers from 1 to about 7, and R^{A} and R^{B} independently selected in each instance from hydrogen, halo, alkyl, alkoxy, and the like. In embodiments that include a multifunctional core, such as a 3-armed star, 4-armed star, 5-armed star, 6-armed star, or even 8-armed core the multifunctional component is included in the polymerization reaction to form the polyester.

In another embodiment, the oligomers are prepared by mixing one or more hydroxy acid monomers, homopolymers, copolymers, block copolymer, and/or graft polymers and one or more lactone monomers above the formulae described herein.

After the polyester is prepared, one or more activated unsaturated carboxylic acids are added. Illustrative activated carboxylic acids include compounds of the formula

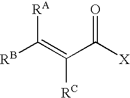

wherein R^{A}, R^{B}, and R^{B} are each independently selected from the group consisting of hydrogen, halo, alkyl, and alkoxy, and X is an activating group displaceable by an hydroxyl group, such as the one or more terminal hydroxyl groups on the polyesters described herein. The activated unsaturated carboxylic acids may be homo or mixed anhydrides as illustrated in FIG. 1, or other activating groups such as acid chlorides, triflates, pentafluorophenyl esters, 2-isocyanatoethyl esters, and the like. In one variation, ester coupling reagents may be included, such as isopropenyl chloroformate, and the like. Further, and with reference to FIG. 1, it is to be understood that in embodiments including a multifunctional core, the length (the integer n) of each oligomeric chain on each function of the multifunctional core may be the same or different.

In another embodiment, syntheses of the polyesters and oligomers are described herein that include ring-opening oligomerization. Illustratively, the prepolymer oligomers described herein are prepared from cyclic hydroxyacids, and cyclized dimers of hydroxy acids. In one aspect the cyclized hydroxy acids include β-lactones, β- and γ-butyrolactones, γ- and δ-valerolactones, ε-caprolactones, and the like. In another aspect, the cyclized dimers of hydroxy acids include homo or mixed dimers of lactic and glycolic acids, optionally substituted analogs thereof, and the like.

In another embodiment, syntheses of the polyesters and oligomers are described herein that include catalysts, such as organotin catalysts. It is appreciated that the use of catalysts may advantageously lower the required reaction temperature, and/or decrease the required reaction time to prepare the polyesters and oligomers.

In embodiments that include a filler, such as β-tricalcium phosphate (β-TCP) the filler is added to liquid or otherwise flowable prepolymer oligomer. In general, the unfilled or filled oligomers described herein may be characterized by average molecular weight, including number average and weight average molecular weight.

Additional syntheses details are described in Ajioka, M., Suizu, H., Higuchi, C., Kashima, T., “Aliphatic polyesters and their copolymers synthesized through direct condensation polymerization,” Polymer Degradation and Stability, 59:137-143 (1998), the disclosure of which is incorporated herein by reference, with optional modifications indicated herein.

The implants described herein may be used in a wide variety of tissue repair, including but not limited to, orthopedics, dentistry, wound healing, tissue restoration, tissue replacement, internal wound closure, external wound closure, and the like. In another embodiment, the implants described herein may be used to construct or prepare any of a number of types of tissue scaffolds for tissue engineering.

In particular, for orthopedic applications, the implants are illustratively useful as biodegradable bone cements, or as restoratives, such as bone grafts, bone defect filling materials, and the like. For dental applications, the implants are illustratively useful as biodegradable restoratives, including dental bone, periodontal, and other restorations. For wound healing applications, the implants are illustratively useful in soft tissue repair, such as wound dressings, skin wound closure, other external wound closure, internal wound closure, and the like. For tissue engineering applications, the implants are illustratively useful preparing soft or hard tissue scaffolds.

It is to be understood that as referred to herein, the implants may be used to repair or supplement in situations arising from accidental injury, from injuries arising from disease states, and injuries resulting from medical procedures.

Bone defects treatable with the implants described herein include fractures at risk of delayed union, nonunion, or malunion, step defects, pits, surface abnormalities, and the like Cartilage defects treatable with the implants described herein include those arising from injury, infection, malignancy, or developmental malformation cartilage lesions that can be caused by traumatic injury to a joint or upon the removal of graft tissue used to treat other sites, such as donor sites in osteochondral grafting lesions or defects can be created during the treatment of tumors involving articular surfaces, or during the removal of cysts. In another embodiment, the unfilled and filled oligomers are suitable for orthopedic restoration, including periodontal restoration. It is appreciated that such orthopedic restoration is most easily accomplished when a prepolymer oligomer such as those described herein is initially introduced into the site in need of repair, and subsequently the oligomer is cured to a filled or unfilled polymer implant.

In particular, the biodegradable materials described herein may be used to repair or supplement the repair of a defect, injury, or other malady in a tissue. In one aspect, the tissue being repaired or supplemented is bone or cartilage. It is appreciated that the implants described herein may be used in conjunction with conventional external and/or internal fixation techniques. In another aspect, the site in need of repair is a wound. Wound closure techniques are generally set forth in Chu, C. C., Anthony von Fraunhofer, J., Greisler, H. P., “Wound closure biomaterials and devices,” Boca Raton, Fla., CRC Press, Inc. (1997), the disclosure of which is incorporated herein by reference.

Additional information regarding orthopedic restorations is found in Kohn, J., Langer, R., (Chap 2) in “An introduction to materials in medicine,” Ratner, B. D., Hoffman, A. S., Schoen, F. J., Lemons, J. K., ed., San Diego, Calif., Academic Press, Inc., 66-72 (1996), the disclosure of which is incorporated herein by reference. Additional information regarding tissue scaffolds for tissue engineering is found in Atala, A., Mooney, D., Vacanti, J., Langer, R., “Synthetic biodegradable polymer scaffolds,” Boston, Mass., Birkhauser (1997), the disclosure of which is incorporated herein by reference.

In another aspect, degradation products of the polymer implants described herein polymers are either absorbed as metabolites by the body or excreted, such as by eliminated through the urine. See generally, An, Y. H., Woolf, S. K., Friedman, R. J., “Pre-clinical in vivo evaluation of orthopedic bioabsorbable devices,” Biomaterials 21:2635-2652 (2000).

### EXAMPLES

The following illustrative Examples describe selected embodiments of the invention. However, such Examples are illustrative only, and should not be construed to limit the invention. All reagents set forth below were used as purchased from commercial suppliers unless otherwise noted.

### Example 1

General synthesis of in situ polymerizable biodegradable polyesters. General synthesis of hydroxyl-terminated oligomeric polyesters with optional multifunctional cores. The hydroxyl-terminated multifunctional oligomeric polyesters are synthesized following the general reaction scheme for the 3-armed core shown in FIG. 1, using condensation polymerization techniques. A mixture of multifunctional core, for example, trimethylolpropane (TMP) and the hydroxy acid monomers, for example GA or LA, or mixtures thereof, where LA refers to a single stereoisomer or a mixture of stereoisomers, are added to a reaction vessel equipped with a Dean Stark trap. The molar ratio of multifunctional core, to hydroxy acid monomer is in the range from about 1:3 to about 1:30, and is illustratively 1:5. In other examples described herein, the ratio of multifunctional core to hydroxy acid monomer is 1:8 or 1:12. It is understood that the higher the number of oligomers, the longer the overall length of the polyester will be. The condensation polymerization reaction is kept at about 200° C. for about 10 hrs. After the reaction is complete, the reactor is cooled and the oligomeric polyester is collected. Yields for hydroxyl-terminated polyesters are generally 96-99%.

### Example 2A

General synthesis of unsaturated ester-terminated oligomeric polyesters with optional multifunctional cores. A solution of unsaturated ester, for example methacrylic anhydride (MAAn) in dry ethyl acetate is added drop wise with stirring at ambient temperature to a solution of multifunctional hydroxyl-terminated oligomeric polyester, pyridine, and dry ethyl acetate. Following addition, the mixture is stirred for another 10 h. After the reaction is complete, the product is purified by precipitating the mixture in hexane, re-dissolving in ethyl acetate, and washing the resulting solution sequentially with 1% aqueous HCl, 3% aqueous NaOH, and brine. The final oily product is obtained by drying the purified organic layer with anhydrous magnesium sulfate followed by evaporation in vacuo. Yields for the ester derivatives are generally 45-75%.

### Example 2B

General synthesis of unsaturated ester-terminated oligomeric polyesters with optional multifunctional cores. A solution of hydroxyl-terminated 3-arm PGA, triethylamine, and dry ethyl acetate is treated with a solution of methacryloyl chloride in dry ethyl acetate, which is added dropwise with stirring at 0° C. The resulting mixture was stirred for another 10 h. After the reaction is completed, the product-containing solution is purified by filtering away the solid triethylamine HCl salts and washing with 3% aqueous NaOH and brine. The washing step is repeated as necessary. The final product (typically an oil) is obtained by drying the purified organic layer (anhydrous magnesium sulfate) followed by evaporating the solvent. Illustrative yields are 75-85%.

### Example 3

Characterization of oligomeric polyesters. The oligomers described herein may be generally identified using Fourier transform infrared spectroscopy (FT-IR, Mattson Research Series FT/IR 1000 spectrophotometer) and nuclear magnetic resonance (NMR, FT-300 MHz Bruker ARX-300 spectrophotometer, deuterated methyl sulfoxide as solvent). Molecular weights (MWs) of the oligomers described herein may be generally determined using a vapor pressure osmometer (K-7000, ICON Scientific, Inc., North Potomac, Md.). The viscosities of the oligomers described herein may be generally measured at ambient temperatures, such as at 23° C., using a programmable cone/plate viscometer (RVDV-II+CP, Brookfield Eng. Lab. Inc., MA, USA).

### Example 4

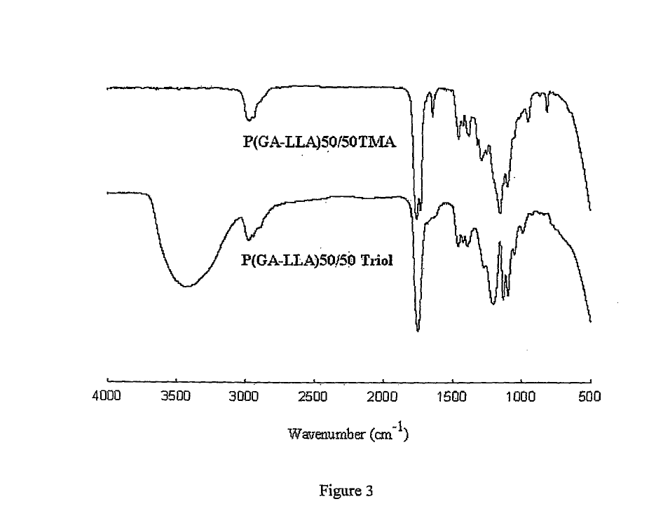

Spectral characterization of hydroxyl-terminated and methacrylate-terminated 3-armed star oligomeric polyesters. The structures of the synthesized hydroxyl-terminated and ester terminated multifunctional core polyesters, synthesized according to the general method described in Examples 1 and 2, were identified with FTIR and 1H-NMR spectroscopy as described in Example 3. The representative FT-IR spectra of PGALLA5050 triols, where equal molar ratios of monomers were used, and trimethacrylates are shown in FIG. 3. The characteristic peaks for PGALLA5050 polyester triols include: (cm-1) 3700-3030 (—OH, broad and strong); 2972 (—CH₂— and —CH₃, medium); 1747 (—C═O, strong and sharp); 1457 and 1394 (—CH₂— and —CH₃, medium); 1208 and 1133 (—O—C—O—, strong), and 990 (—CH₃, small). The peaks for PGALLA5050 trimethacrylates are; 2966 (C—H, medium); 1753 and 1726 (C═O, strong); 1636 (C═C, sharp and medium); 1454, 1426 and 1381 (—CH₃, —CH₂—, —CH₃); 1155 and 1101 (—O—C—O—, strong); 946 (—CH₃, small); and 813 (C═C, medium). Disappearance of hydroxyl group at 3700-3030 and formation of C═C at 1636 confirmed the complete conversion of PGALLA050 polyester triols to trimethacrylates.

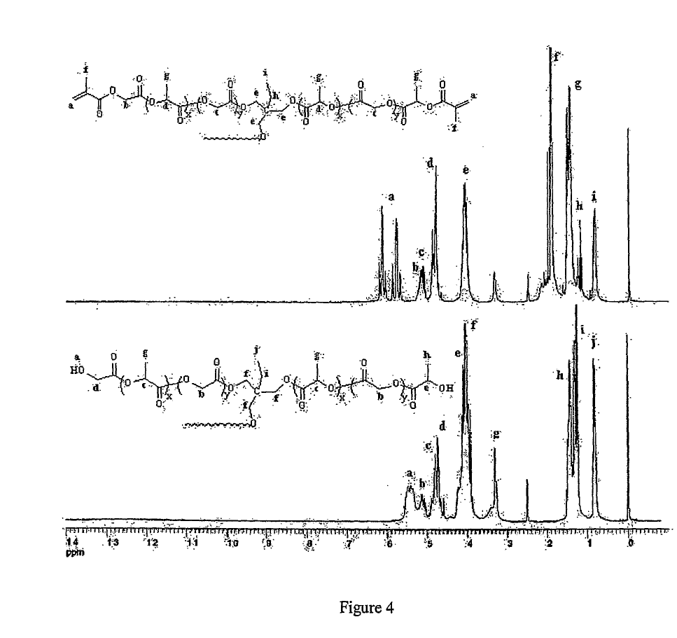

¹H NMR spectra of the synthesized hydroxyl-terminated and methacrylate-terminated 3-armed star polyesters are shown in FIG. 4, the chemical shifts of PGALLA5050 polyester triols are as follows: (ppm) a: 5.5 (OH); b: 5.1 (CH₂ on the internal GA); c: 4.85 (CH on the internal LLA); d: 4.7 (CH₂ on the GA close to the end OH); e: 4.2 (CH on the LLA close to the end OH); f: 4.0 (CH₂ on the TMP core); g: 3.3 (CH₃ on the internal LLA); h: 1.5 (CH₃ on the LLA close to the end OH); i: 1.3 (CH₂ on the ethyl group of the TMP core); and j: 0.85 (CH₃ on the ethyl group of the TMP core). It is understood that in each instance the multiplicities “x” and “y” of the polymers are potentially different, and may be any integer from about 1 to about 20,000. That range corresponds to an illustrative range of number molecular weights that contributes to the number average molecular weight range described herein. Therefore, the structures in FIG. 4 should be understood to include oligomeric backbones from completely random alternating oligomers, to varying degrees of block copolymer architecture.

The chemical shifts of PGALLA5050 polyester trimethacrylates are as follows: (ppm) a: 5.8 and 6.2 (CH₂═); b: 5.2 (CH₂ on the GA close to methacrylate); c: 5.1 (CH₂ on the internal GA); d: 4.75 (CH on the internal LLA); e: 4.0 (CH₂ on the TMP core); f: 2.0 (CH₃ on the methacrylate end); g: 1.5 (CH₃ on the internal LLA); h: 1.2 (CH₂ on the ethyl group of the TMP core); and i: 0.75 (CH₃ on the ethyl group of the TMP core). The two typical chemical shifts at 5.8 and 6.2 identified the carbon-carbon double bond formations on PGALLA5050 polyester trimethacrylates.

### Example 5

MW and viscosity evaluations of oligomers. Hydroxyl-terminated and ester-terminated multifunctional cores were synthesized according to the general method described in Examples 1 and 2, and characterized as described in Example 3. Table 1 shows the molar ratio and number average molecular weights (MWs) of the 3-armed star polyester triols, and the viscosities of the 3-armed star polyester trimethacrylates. The multifunctional core molecule, trimethylolpropane (TMP), was coupled to polyester trimethacrylates (PGA, PGALLA and PLLA) of poly(glycolic acid), poly(L-lactic acid), and copolymers of GA and LLA. Three different molar ratio copolymers of GA and LLA were tested (GA/LLA=50:50, GA/LLA=25:75, and GA/LLA=75:25). The different molar ratios of copolymers affect the composition of the polyester chains in the multifunctional core polyesters. For example, it is appreciated that the varying ratios of hydroxy acid monomers may affect the overall distribution of the various monomers along the polymer chain. In one aspect the distribution may be purely statistical based on the relative ratio of monomers. In another aspect, the distribution may be controlled by the thermodynamics and kinetics due to the structural and reactive differences between the monomers themselves. The values for the molecular weight of the 3-armed star polyester alcohol was determined by a vapor pressure osmometer. The viscosity of 3-armed star polyester TMA was determined by a cone/plate viscometer. The number average MWs for all the polyesters synthesized in these Examples were similar, ranging from 361 to 460.8 Dalton. The viscosities of the polyester trimethacrylates ranged from 46.8 to 133.8 cp, with the highest for PLLA, followed in order of decreasing viscosity by PGA, PGALLA7525, PGALLA5050, and PGALLA2575. Each Example was in a liquid state.

TABLE 1
Molar Ratio, MW and Viscosity of 3-armed
core polyester methacrylates.

| | Molar Ratio | | Viscosity |
|---|---|---|---|
| Material | (GA:LLA) | MW | (cp) |
| PGA | 100:0 | 395.7 | 105.5 |
| PGALLA7525 | 75:25 | 361.0 | 80.1 |
| PGALLA5050 | 50:50 | 447.7 | 50.8 |
| PGALLA2575 | 25:75 | 460.8 | 46.8 |
| PLLA | 0:100 | 394.9 | 133.8 |

### Example 6

Length of polyesters. The effect of increased molecular weight of the glycolic acid/lactic acid-based composite was examined. Ester terminated multifunctional core polyesters synthesized as described in Examples 1 and 2, for example glycerol core and GA/LLA or GA/DLLA monomers, terminated with trimethacrylate, are shown in Table 2, along with the initial YCS, M, and UCS of the cured filled implant material. In both cases, the smaller ratio of monomer to core molecule exhibited higher YCS, UCS, and Modulus values.

TABLE 2
Effect of MW on initial compressive properties.

| | | YCS³ | Modulus | UCS⁴ | |
|---|---|---|---|---|---|
| Liquid resin¹ | Matrix² | (MPa) | (GPa) | (MPa) | |
| PGALLA5050R5 | β-TCP | 66.2 (5.7)⁵ | 2.50 (0.55) | 137.8 | (7.8)^{a} |
| PGALLA5050R8 | β-TCP | 29.3 (1.3) | 1.21 (0.23) | 131.6 | (7.9)^{a} |
| PGALLA5050R12 | β-TCP | 2.8 (0.3) | 0.33 (0.09) | 94.6 | (3.2) |
| PGADLLA5050R5 | β-TCP | 57.3 (1.8) | 2.58 (0.08) | 161.8 | (12) |
| PGADLLA5050R8 | β-TCP | 40.6 (1.2) | 1.86 (0.02) | 146.4 | (3.8) |
| PGADLLA5050R12 | β-TCP | 8.1 (0.7) | 0.53 (0.08) | 103.8 | (3.7) |

¹Glycerol was used as the core monomer. MW: R12 > R8 > R5, where R5 = Monomer/core molecule = 5/1, R8 = 8/1 and R12 = 12/1. PGALLA5050 and PGDLLA5050 were used for preparation of composites.
²Beta-TCP = 50% (by weight).
³YCS = CS at yield.
⁴UCS = ultimate CS.
⁵Entries are mean values with standard deviations in parentheses and the mean values with the same superscript letter were not significantly different (p > 0.05).

### Example 7A

Cured unfilled polymers. FIG. 2 generally illustrates the preparation of cured unfilled implant material. Specimens of unfilled resins were fabricated by thoroughly mixing the methacrylate-terminated 3-armed star polyester with DL-camphorquinone (CQ) (1.0 wt %, a photo-initiator) and 2-(dimethylamino)ethyl methacrylate (DMAEM) (2.0 wt %, an activator), placing them into desirable molds, and immediately exposing the tubing to blue light using an EXAKT 520 Blue Light Polymerization Unit (9W/71, GmbH, Germany) for 10 min at ambient temperature. The cured specimens were removed from the mold and conditioned prior to testing. Additional synthetic and preparation details, including conditioning, are described in Xie, D., Chung, I-D., Puckett, A., Mays, J. “Novel biodegradable amino acid-containing anhydride oligomers for orthopedic application,” J Appl Polym Sci 96(5): 1979-1984 (2005) and Chung, I-D., Xie, D., Puckett, A., Mays, J., “Syntheses and evaluation of novel biodegradable amino acid based anhydride polymer resins and composites,” Eur Polym J 39:497-503 (2003), the disclosures of which are incorporated herein by reference.

### Example 7B

Cured filled polymers. FIG. 2 generally illustrates the preparation of cured filled implant material. Composite oligomers may be prepared using various ratios of oligomer to filler. Illustratively, the filler in this Example was β-TCP included at 50% by weight, unless otherwise specified. The filler was pretreated with 3-(trimethoxysilyl)propyl methacrylate before mixing with the oligomer. Two portions (A and B) were prepared from the composite oligomer. Portion A was included 1 wt % benzoyl peroxide (BPO) as an initiator, and Portion B included 1 wt % N,N′-dimethyl-para-toluidine (DMT) as an activator. The specimens for composites were fabricated by mixing equal amounts of Portions A and B at ambient temperature, immediately placing the mixture into desirable molds. After 30 minutes, the specimens were removed from the molds, and conditioned before testing.

### Example 8

Curing time, exotherm, and degree of conversion (DC) measurements. A metal rod was used to evaluate the curing time, as generally described by Xie, D., Feng, D., Chung, I-D., Eberhardt, A. W., “A hybrid zinc-calcium-silicate polyalkenoate bone cement,” Biomaterials 24:2749-2757 (2003), the disclosure of which is incorporated herein by reference. The rod was inserted into the center of a mixture of Portions A and B, immediately after the two-components were mixed and packed into a two-end opened glass tubing with diameter of 4 mm. Curing time equaled the period from which the mixing process was initiated to the moment at which the metal rod could not be moved by hand. The average was obtained by every three readings.

The heat generated from the setting reaction of the cured implant material was determined by the ASTM F-451 procedure, as generally described in Xie, D., Feng, D., Chung, I-D., Eberhardt, A. W., “A hybrid zinc-calcium-silicate polyalkenoate bone cement,” Biomaterials 24:2749-2757 (2003), modified as follows. The well-mixed Portions A and B of paste were placed in a cylindrical Teflon mold with dimensions of 30 mm in diameter by 6 mm in height and covered with a Teflon plunger having holes for allowing the excessive cement to escape. A digital thermocouple was inserted in the center of the composite and used to record the temperature change. The peak temperature was defined as the exotherm. The results were a net temperature change. The average was obtained by every three readings.

The degree of conversion (DC) for the resin and composites were measured in potassium bromide (KBr) crystals using FT-IR and calculated based on the method described by Wang, G.; Culbertson, B. M.; Xie D.; Seghi, R. R. J Macro Sci P&A Chem A36(2):225 (1999), the disclosure of which is incorporated herein by reference.

### Example 9

Strength measurements of implant material. Cylindrical specimens for compressive (CS) and diametral tensile strength (DTS) tests were prepared in glass tubing with dimensions of 4 mm in diameter by 8 mm in length for CS, and with dimensions of 4 mm in diameter and 2 mm in thickness for DTS. The specimens for the flexural strength (FS) test were prepared using a rectangular Teflon mold with dimensions of 3 mm in width by 3 mm in depth by 25 mm in length. Generally, diametral tensile strength tests showed the same trends as compressive tests.

Mechanical testing of specimens was performed on a screw-driven mechanical tester (QTest QT/10, MTS Systems Corp., Eden Prairie, Minn.) with a crosshead speed of 1 mm/min for all strength measurements, as generally described in Xie, D., Chung, I-D., Puckett, A., Mays, J. “Novel biodegradable amino acid-containing anhydride oligomers for orthopedic application,” J Appl Polym Sci 96(5):1979-1984 (2005) and Chung, I-D., Xie, D., Puckett, A., Mays, J., “Syntheses and evaluation of novel biodegradable amino acid based anhydride polymer resins and composites,” Eur Polym J 39:497-503 (2003). The FS test was performed in three-point bending, with a span of 20 mm between supports. The CS at fracture was defined as the maximum stress carried by the specimen during test and calculated from the equation CS═P/πr², where P is the load at fracture and r the radius of the sample cylinder. The DTS was determined from the relationship DTS=2P/πdt, where P=the load at fracture, d=the diameter of the cylinder and t=the thickness of the cylinder. The FS in three-point bending was obtained using the expression FS=3P1/2bd², where P the load at fracture, 1 the distance between the two supports, b the breadth of the specimen, and d the depth of the specimen. Compressive yield strength (YCS), modulus (M), ultimate strength (UCS) and toughness (T) from the CS test were determined from a stress-strain curve.

### Example 10

Effect of GA/LLA molar ratio on initial mechanical properties. Tables 3 and 4 show the initial values of YCS, M, UCS and T of the cured unfilled implant materials and cured filled implant materials, respectively. For the cured unfilled resins, PGA exhibited the highest YCS (20.1 MPa), M (730 MPa), UCS (310.5 MPa) and T (3.93 KN·mm), followed by PGALLA7525, PGALLA5050, PGALLA2575 and PLLA, as shown in Table 3. Without being bound by theory, it is suggested that the significantly high compressive strengths of the PGA resin may be attributable to a strong dipole-dipole molecular interaction between polyester linkages, as described in Solomons, G., Fryhle, C., “Organic Chemistry,” 7^{th} ed. New York, N.Y.: John Wiley & Sons, Inc. (2000). Further it is suggested that the relatively lower strengths of the PLLA resin may be attributed to the pendant methyl groups that make more free volume between polymer chains and thus the weaker molecular interaction. With decreasing relative amounts of GA in polyester polymer network, the dipole-dipole interaction may correspondingly weaken, leading to decreased strength. Regardless, significantly high initial compressive properties including yield strength (YCS), modulus (M), ultimate strength (UCS) and toughness (T) compared to conventional implant materials is shown in Tables 3 and 4.

TABLE 3
Initial compressive properties of the cured unfilled resins.

| | YCS¹ | | Modulus | | UCS² | | Toughness | |
|---|---|---|---|---|---|---|---|---|
| Unfilled Resin* | (MPa) | | (MPa) | | (MPa) | | (KN · mm) | |
| PGA | 20.1 | (1.6) | 730.2 | (35) | 310.5 | (19) | 3.93 | (0.72) |
| PGALLA7525 | 16.5 | (1.4) | 553.4 | (54) | 195.5 | (11) | 2.47 | (0.22) |
| PGALLA5050 | 8.5 | (0.9) | 362.9 | (25) | 153.5 | (15) | 1.89 | (0.13) |
| PGALLA2575 | 5.8 | (0.8) | 204.5 | (13)^{a} | 108.1 | (9.3) | 1.27 | (0.02)^{b} |
| PLLA | 4.0 | (0.3) | 201.5 | (26)^{a} | 82.7 | (3.2) | 1.02 | (0.11)^{b} |

*Trimethyl propane was used as the core molecule.
¹YCS = CS at yield;
²UCS = ultimate CS.
³Entries are mean values with standard deviations in parentheses -- mean values with the same superscript letter are not significantly different (p > 0.05).

Filled implant material was prepared by mixing the unfilled resins shown in Table 3 with β-TCP fillers in a 50:50 ratio by weight, and curing by redox initiation as described herein. After curing, the strengths were measured and are shown in Table 4. The filled implant exhibited the same trend in strength as the unfilled resins when as a function of hydroxy acid monomer ratio. The PGA-composed composite demonstrated the highest YCS (56.4 MPa), M (2.46 GPa), UCS (158.9 MPa) and T (1.97 KN·mm), followed by PGALLA7525, PGALLA5050, PGALLA2575 and PLLA composed composites. In addition, the composites showed much higher YCS (27.7-56.4 MPa) and M (1.44-2.46 GPa) but not necessarily higher UCS (81.6-158.9 MPa) and T (0.94-1.97 KN·mm), as compared to the unfilled resins (4.0-20.1, 0.21-0.73, 82.7-310.5 and 1.02-3.93). Without being bound by theory, it is suggested that this difference may be attributed to the difference in nature between polymers versus ceramics and glasses.

TABLE 4
Initial compressive properties of the cured composites.

| | | YCS² | | Modulus | | UCS³ | | Toughness | |
|---|---|---|---|---|---|---|---|---|---|
| Liquid resin* | Matrix¹ | (MPa) | | (GPa) | | (MPa) | | (KN · mm) | |
| PGA | β-TCP | 56.4 | (3.3) | 2.46 | (0.09)^{b} | 158.9 | (2.8)^{c} | 1.97 | (0.05)^{e} |
| PGALLA7525 | β-TCP | 65.7 | (4.0) | 3.11 | (0.22) | 152.4 | (12)^{c,d} | 1.77 | (0.31)^{e} |
| PGALLA5050 | β-TCP | 45.7 | (1.9)^{a} | 2.84 | (0.09)^{b} | 139.0 | (7.9)^{d} | 1.65 | (0.19)^{e} |
| PGALLA2575 | β-TCP | 38.0 | (3.4)^{a} | 1.81 | (0.30) | 98.7 | (5.8) | 1.19 | (0.12) |
| PLLA | β-TCP | 27.7 | (4.2) | 1.44 | (0.36) | 81.6 | (4.3) | 0.94 | (0.07) |

*Trimethyl propane was used as the core molecule.
¹β-TCP = 50%;
²YCS = CS at yield;
³UCS = ultimate CS.
⁴Entries are mean values with standard deviations in parentheses -- mean values with the same superscript letter are not significantly different (p > 0.05).

### Example 11

Effect of optically pure components on initial mechanical properties. The use of optically pure amino acids in the composites were examined. Initial compressive properties of composites using enantiomerically pure L-lactic acid (LLA) compared to racemic lactic acid (DLLA) and a glycerol multifunctional core (ratio of monomer/core molecule=5:1) is shown in Table 5 and Table 6.

TABLE 5
Initial compressive properties of
the cured GA/LLA-based composites

| | | YCS³ | | Modulus | | UCS⁴ | |
|---|---|---|---|---|---|---|---|
| Liquid resin¹ | Matrix² | (MPa) | | (GPa) | | (MPa) | |
| PGA | β-TCP | 81.8 | (3.4)⁵ | 3.24 | (0.21)^{b} | 197.3 | (9.3)^{d} |
| PGALLA7525 | β-TCP | 69.9 | (4.1)^{a} | 2.92 | (0.27)^{b,c} | 182.5 | (16)^{d} |
| PGALLA5050 | β-TCP | 66.2 | (5.7)^{a} | 2.50 | (0.55)^{c} | 137.8 | (7.8)^{e} |
| PGALLA2575 | β-TCP | 40.7 | (1.9) | 2.04 | (0.17) | 114.8 | (5.8) |
| PLLA | β-TCP | 39.1 | (1.6) | 1.63 | (0.27) | 143.2 | (16)^{e} |

¹Glycerol was used as the core molecule. Monomer/core molecule = 5/1.
²β-TCP = 50% (by weight);
³YCS = CS at yield;
⁴UCS = ultimate CS.
⁵Entries are mean values with standard deviations in parentheses and the mean values with the same superscript letter were not significantly different (p > 0.05).

TABLE 6
Initial compressive properties of
the cured GA/DLLA-based composites

| | | YCS³ | | Modulus | | UCS⁴ | |
|---|---|---|---|---|---|---|---|
| Liquid resin¹ | Matrix² | (MPa) | | (GPa) | | (MPa) | |
| PGA | β-TCP | 81.8 | (3.4)⁵ | 3.24 | (0.21) | 197.3 | (9.3) |
| PGADLLA7525 | β-TCP | 53.4 | (1.9)^{a} | 2.26 | (0.47)^{b} | 169.5 | (9.6)^{c} |
| PGADLLA5050 | β-TCP | 57.3 | (1.8)^{a} | 2.58 | (0.08)^{b} | 161.8 | (12)^{c} |
| PGADLLA2575 | β-TCP | 54.6 | (3.3)^{a} | 2.41 | (0.29)^{b} | 146.2 | (7.3) |
| PDLLA | β-TCP | 43.6 | (1.2) | 1.91 | (0.37) | 117.0 | (4.0) |

¹Glycerol was used as the core molecule. Monomer/core molecule = 5/1.
²β-TCP = 50% (by weight);
³YCS = CS at yield;
⁴UCS = ultimate CS.
⁵Entries are mean values with standard deviations in parentheses and the mean values with the same superscript letter were not significantly different (p > 0.05).

### Example 12

Effect of filler ratio on initial mechanical properties. Table 7 shows the initial YCS, M, UCS and T of the cured filled implant material with different β-TCP loading. The data in Table 7 indicates that increasing filler content may generally increase YCS and compressive modulus, but may generally decrease UCS and toughness.

TABLE 7
Initial compressive properties of the cured composites of
glycolic acid oligomers with different filler ratios.

| | YCS¹ | Modulus | UCS² | | Toughness |
|---|---|---|---|---|---|
| Filler (%) | (MPa) | (GPa) | (MPa) | | (KN · mm) |
| 0 | 20.1 (1.6)³ | 0.73 (0.04) | 310.5 | (19) | 3.93 (0.72) |
| 20 | 38.7 (2.8) | 1.52 (0.08) | 261.9 | (16) | 3.84 (0.22) |
| 33 | 43.2 (4.2) | 1.82 (0.11) | 216.1 | (8.8) | 3.16 (0.21) |
| 43 | 51.1 (1.5) | 1.97 (0.22) | 182.7 | (4.9) | 2.46 (0.14) |
| 50 | 56.4 (3.3) | 2.46 (0.09) | 158.9 | (2.8) | 1.97 (0.05) |
| 60 | 63.5 (2.3) | 2.87 (0.31) | 130.8 | (6.2) | 1.32 (0.07) |
| 67 | 86.4 (6.9) | 4.87 (0.31) | 125.1 | (13) | 0.98 (0.22) |
| 75 | 92.3 (3.9) | 5.65 (0.27) | 119.9 | (5.6) | 0.63 (0.05) |

¹YCS = CS at yield;
²UCS = ultimate CS.
³Entries are mean values with standard deviations in parentheses and the mean values with the same superscript letter were not significantly different (p > 0.05)

FIG. 6A shows the CS, DTS and FS values for cured implant material prepared from oligomers of glycolic acid having different filler ratios. The unfilled resin showed the highest ultimate CS. Both unfilled resin and 33% β-TCP filled composite showed the highest DTS. Increasing the filler ratio appears to generally decrease both CS and DTS, which is consistent with the observation that the cured unfilled resin showed the highest CS. No significant changes in either CS or DTS were observed at filler ratios above 60%. FS appears to be optimized at intermediate fill levels, and that optimum is about 43% filler in this Example.

FIG. 6B shows the CS and DTS values for cured implant material prepared from oligomers of glycolic acid having different filler ratios. In this Example, some of the samples shown in FIG. 6A were repeated, and additional samples were prepared with filler ratios as high as 75%. As in FIG. 6A, the unfilled resin showed the highest ultimate CS. However, in this Example, the unfilled resin and the 20% β-TCP filled composite showed the highest DTS values. Increasing the filler ratio appears to generally decrease both CS and DTS, which is consistent with the observation that the cured unfilled resin showed the highest CS. No significant changes in either CS or DTS were observed at filler ratios above 60%.

### Example 13

Effect of filler ratio on initial mechanical properties. Table 8 illustrates another set of experiments showing the initial YCS, M, and UCS of the cured filled implant material with different β-TCP to polymer ratios. The data in Table 8 indicates that increasing filler content may generally increase YCS (from 68.7 MPa at 33% filler, to 126.9 MPa at 75% filler) and compressive modulus (from 2.39 MPa at 33% filler, to 6.5.9 MPa at 75% filler), but may generally decrease UCS (from 250.8 MPa at 33% filler, to 146.3 MPa at 75% filler).

TABLE 8
Effect of filler content on initial mechanical
properties, GA-based composites.

| | YCS² | | Modulus | UCS³ |
|---|---|---|---|---|
| Filler¹ (%) | (MPa) | | (GPa) | (MPa) |
| 33 | 68.7 | (1.2)⁴ | 2.39 (0.11) | 250.8 (16) |
| 50 | 81.8 | (3.4) | 3.24 (0.21) | 197.3 (9.3) |
| 67 | 113.9 | (4.0) | 5.46 (0.09) | 171.9 (2.0) |
| 75 | 126.9 | (7.3) | 6.59 (0.26) | 146.3 (7.1) |

¹Glycerol was used as the core molecule. PGA was used for preparation of composites. Monomer/core molecule = 5/1. Filler = β-TCP (by weight).
²YCS = CS at yield;
³UCS = ultimate CS.
⁴Entries are mean values with standard deviations in parentheses and the mean values with the same superscript letter were not significantly different (p > 0.05).

### Example 14

Curing time, exotherm and degree of conversion. The curing time, exotherm, and degree of conversion (DC) of the composites were determined, and are shown in Table 9. Effects of both GA/LLA molar ratio and filler ratio were studied. The curing time of the PGA, PGALLA7525, PGALLA5050, PGALLA2575 and PLLA was in the range of 2.1 to 6.2 min. Increasing LLA molar ratio in the composites appears to increase the curing time. Without being bound by theory, it is suggested that the curing time may be increasing due to fewer carbon-carbon double bonds in the composites containing more LLA. In this Example, a weight ratio instead of a molar ratio was used when the composites were prepared. Therefore, in the same amount of cured composites, higher LLA ratios translates into a lower overall concentration of carbon-carbon double bonds, leading to an increased curing time. The exotherm of these composites was low (temperature increase from 3.9 to 4.6) for all molar ratios, which is consistent with having the same filler level. Increasing LLA ratio appears to decrease the DC of the composites from 79.6 to 69.8%.

Regarding the effect of filler content, increasing filler content increased curing time from 2.0 to 2.45 min. Without being bound by theory, it is suggested that increasing filler content may decrease the local concentration of polymerizable resin and thus slow down the curing. For the exotherm, all the materials including unfilled resin showed low temperature increases ranging from 2.5 to 6.6° C. For comparison, commercial PMMA bone cement exhibits a substantial exotherm of up to 86.8° C., representing a temperature increase of 55-61° C. See, Xie, D., Feng, D., Chung, I-D., Eberhardt, A. W., “A hybrid zinc-calcium-silicate polyalkenoate bone cement,” Biomaterials 24:2749-2757 (2003).

Regarding DC, it appears that increasing filler content decreases DC. Except for the unfilled resin, the composite with 33% filler showed the highest DC (85.3%) and the composite with 67% filler showed the lowest DC (72.9%).

TABLE 9
Curing time, exotherm, and degree of
conversion of the cured composites.

| | | | |
|---|---|---|---|
| | | Exotherm | |
| Filler (%) | Curing time (min) | (° C.) | DC (%) |

Effect of GA/LLA molar ratio

| | | | |
|---|---|---|---|
| PGA | 2.20 | 4.6 | 79.6 |
| PGALLA7525 | 2.10 | 4.7 | 75.0 |
| PGALLA5050 | 2.55 | 4.5 | 70.8 |
| PGALLA2575 | 3.13 | 4.2 | 70.8 |
| PLLA | 6.20 | 3.9 | 69.8 |

Effect of filler content

| | | | |
|---|---|---|---|
| 0 | N/A | 6.5 | 81.8 |
| 20 | 1.89 (0.04)¹ | 6.6 | 88.1 |
| 33 | 2.07 (0.11) | 5.5 | 85.3 |
| 43 | 2.18 (0.09) | 5.0 | 85.2 |
| 50 | 2.25 (0.04) | 4.6 | 79.5 |
| 60 | 2.34 (0.09) | 2.9 | 75.6 |
| 67 | 2.51 (0.08) | 2.5 | 72.9 |
| 75 | 2.93 (0.12) | 2.1 | 69.8 |

### Example 15

Multifunctional core characteristics. The initial compressive properties of composites with different cores is shown in Table 10. As shown, 3-armed resins have higher YCS, M, and UCS values for both PGA and PGALLA (equal ratios) resins. The lowest values were obtained for composites that contained 6-arm core structures. The data indicates that increasing the substitution of the core molecule decreases the overall values for YCS, M, and UCS.

TABLE 10
Effect of arm number on initial compressive properties

| | | YCS³ | Modulus | UCS⁴ | |
|---|---|---|---|---|---|
| Liquid resin¹ | Matrix² | (MPa) | (GPa) | (MPa) | |
| 3-arm PGA | β-TCP | 81.8 (3.4)⁵ | 3.24 (0.21) | 197.3 | (9.3)^{b} |
| 4-arm PGA | β-TCP | 54.7 (2.8) | 2.20 (0.14) | 186.2 | (14)^{b,c} |
| 6-arm PGA | β-TCP | 24.9 (2.0) | 1.13 (0.11) | 172.1 | (10)^{c} |
| 3-arm | β-TCP | 66.2 (5.7) | 2.50 (0.55) | 137.8 | (7.8)^{d} |
| PGALLA5050 | | | | | |
| 4-arm | β-TCP | 19.2 (1.0) | 0.97 (0.11)^{a} | 129.7 | (3.5)^{d} |
| PGALLA5050 | | | | | |
| 6-arm | β-TCP | 11.6 (1.1) | 0.68 (0.04)^{a} | 117.8 | (6.8) |
| PGALLA5050 | | | | | |

¹For 3-arm, 4-arm and 6-arm, glycerol, pentaerythritol and dipentaerythritol were used as core molecules, respectively. Both PGA and PGALLA5050 were used for preparation of composites. Monomer/core molecule = 5/1.
²β-TCP = 50% (by weight);
³YCS = CS at yield;
⁴UCS = ultimate CS.
⁵Entries are mean values with standard deviations in parentheses and the mean values with the same superscript letter were not significantly different (p > 0.05).

### Example 16

Biodegradation studies. Degradation studies were conducted at 37±2° C. in PBS solution with pH=7.4 to mimic the in vivo environment, as described in Xie, D., Chung, I-D., Puckett, A., Mays, J. “Novel biodegradable amino acid-containing anhydride oligomers for orthopedic application,” J Appl Polym Sci 96(5):1979-1984 (2005) and Chung, I-D., Xie, D., Puckett, A., Mays, J., “Syntheses and evaluation of novel biodegradable amino acid based anhydride polymer resins and composites,” Eur Polym J 39:497-503 (2003). The PBS was changed frequently for the first week and then whenever the pH changed, to keep the pH constant for all the samples. The specimens were collected at 1, 3, 7, 14, 30, 60 and 90 days. The degradation of the materials was characterized by evaluating the change in ultimate CS values.

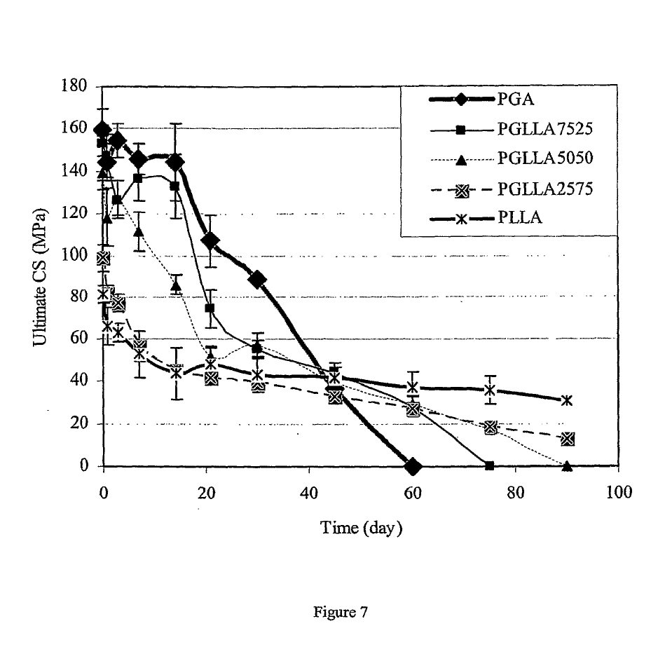

Both the effects of molar ratio and of filler content on degradation were investigated. The degradation was evaluated based on loss of ultimate CS as a function of time. The effect of molar ratio is shown in FIG. 7. All the tested materials exhibited a burst degradation behavior within the first 24 h. The PLLA composite lost nearly 19% of its original UCS, followed by the PGALLA2575, PGALLA5050, PGA, and PGALLA7525 composites (losses of 17%, 15%, 9% and 3.6%, respectively). Without being bound by theory, it is suggested that the burst effect may be attributed to a quick sample surface degradation because the surface is often the more sensitive portion to the water environment. Nearly all of the composites showed an increase in UCS from either Day 1 to Day 3 (PGA, PGALLA5050 and PLLA) or Day 3 to Day 7 (PGALLA7525). T his increased CS may be attributed to the formation of salt-bridges or other ionic bonds within the composites during the course of degradation. As the carboxylic acid concentration produced from the backbone degradation increases, salt-bridges may form between the carboxyl groups on polymer fragments and calcium cations from the G-TCP, resulting in “an ionomer”. The ionic crosslinks combined with partially degraded polymer networks (still having relatively high molecular weight) may account for the resulting increase in CS. By Day 14, the PGA and PGALLA7525 showed either less change or no change compared to the observations at Day 7. In contrast, the PGALLA5050, PGALLA2575 and PLLA composites showed 38%, 54% and 46% loss of their original UCS. At Day 30, the PGALLA7525 lost the most CS (64% of its original), followed by the PGALLA2575 (60%), PGALLA5050 (54%), PLLA (47%) and PGA (44%). The PGALLA2575 and PLLA showed either little change or no change, respectively, from Day 14 to Day 45. This little or no change in strength may also be partially attributed to the nature of salt-bridge self-healing. See, Davidson, C. L. and Mjör, I. A. “Advances in Glass-Ionomer Cements” Chicago, Quintessence Publ Co. (1999). It is appreciated that these results support the use of the described implant materials in orthopedic restorations that may require initial and sustained mechanical support during the recovery of bone tissue.

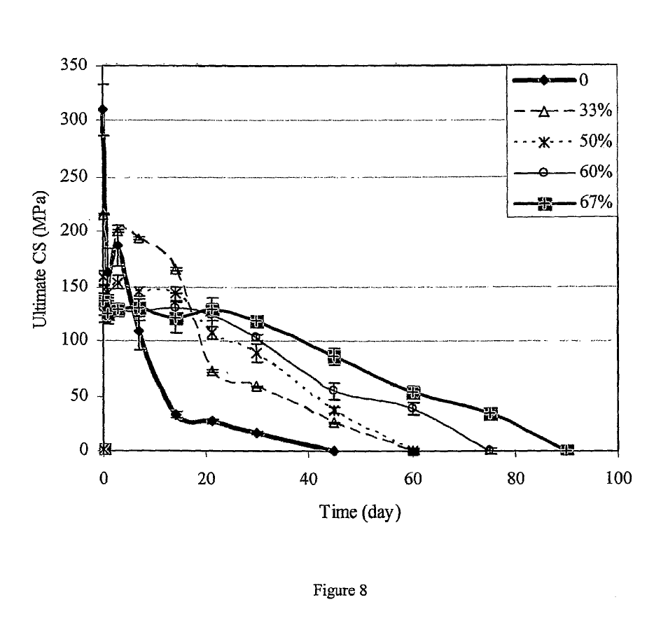

FIG. 8 shows the effect of filler content on degradation of the filled composites of glycolic acid oligomers. As compared to those in FIG. 7, all the tested materials in FIG. 8 exhibited an even higher burst degradation behavior within the first 24 h. The PGA with 0% filler (unfilled resin) lost the most, nearly 47%, of its original ultimate CS, followed by the composites with 33%, 50%, 60% and 67% (losing 35%, 10%, 11% and 9%, respectively). All the materials showed an increase in CS from Day 1 to Day 3. The composite with 33% filler showed the highest increase (45%), followed by the materials with 0%, 50%, 60% and 67% (increased 15%, 9%, 5% and 4%, respectively). It appears that the lower the filler ratio, the greater CS increased from Day 1 to Day 3, which is consistent with the observation that more resin appeared to lead to a faster degradation as compared to the higher filler-containing composites. By Day 7, only the unfilled resin showed a significant decrease (losing 42% as compared to the CS measured at Day 3) and the others showed little or no change. It is appreciated that these results support the use of the described implant materials in orthopedic restorations that may require initial and sustained mechanical support during the recovery of bone tissue.

By Day 14, the unfilled resin and low filler-containing composite (33%) showed a significant decrease in CS (69% and 14%) but the others showed either no change or a little increase, indicating that the composites with a filler content higher than about 43% may retain their strengths by Day 14. The actual remaining UCS values for the materials at Day 14 were: 32.8, 166, 144, 130 and 121.2 MPa, for the composites with 0%, 33%, 50%, 60% and 67%, respectively. As compared to the original UCS, they lost 89%, 23%, 9%, 0% and 11% of their original strengths, respectively. These results show that the higher the filler content in the composite, the slower the degradation. By Day 21, all the materials showed a significant decrease in CS except for the composites with 60% and 67% fillers. The data at Day 30 indicate that the materials continued to show a tendency of decrease in strength. By Day 45, the unfilled resin completely lost its strength, and some individual specimens completely lost their integrity. The UCS values for the other materials were: 25.4, 36.9, 54.6 and 86.1 MPa, for 33%, 50%, 60% and 67%, respectively. At Day 60, the 33% and 50% filled materials completely lost their CS. The UCS values for the remaining two composites (60% and 67%) were 38.2 and 53.0 MPa, respectively.

Without being bound by theory, it is suggested that the significant reduction in UCS after either 14 or 21 days (depending on filler content) may be explained that as degradation continues, the molecular weight of the polymer resin becomes decreases, and the formed salt-bridges are no longer able to offset the strength reduction caused by degradation. As a result, a significant decrease in CS is measured.

### Example 17

Stabilization of uncured resin for storage. Samples of uncured curable resin compositions described herein were stabilized by addition of a polymerization inhibitor. Two different resin compositions were tested, each with a different polymerization initiator. Each of the two resin compositions were stabilized with varying concentrations of several storage stabilizers. The results of the stability of the resin compositions over time is shown in Table 11.

TABLE 11
Effect of Stabilizer on Storage of Resins Containing Initiator(s)

| | | |
|---|---|---|
| Inhibitor¹ | Duration for Resin I | Duration for Resin II |
| (%, by weight) | stability² | stability³ |

| | | | | | |
|---|---|---|---|---|---|
| 0.05 | BHT | 7 | days | 3 | hrs |
| 0.10 | BHT | 10 | days | 24 | hrs |
| 0.25 | BHT | >3 | months | >3 | months |
| 0.05 | HQ | 7 | days | 3 | hrs |
| 0.10 | HQ | 10 | days | 24 | hrs |
| 0.25 | HQ | >3 | months | >3 | months |
| 0.025 | MEHQ | 24 | hrs | 24 | hrs |
| 0.05 | MEHQ | >6 | months | >6 | months |
| 0.10 | MEHQ | >6 | months | >6 | months |
| 0.25 | MEHQ | >6 | months | >6 | months |

¹BHT, HQ and MEHQ are three commercially available stabilizers or inhibitors; The tested resin liquid was stored at ambient temperature (23-25° C.); The stability was determined by observing the resin liquid to see if the liquid is self-polymerized or not.
²Resin I is composed of PGA trimethacrylates containing BPO as the initiator (1% by weight);
³Resin II is composed of PGA trimethacrylates containing DMT as the initiator (1% by weight).

The foregoing description and accompanying Examples describe various illustrative embodiments of the invention. However, it is to be understood that many variations are contemplated, including but not limited to, the choice of monomers, optional multifunctional cores, and optional graft polymers. Additional contemplated variations include different chemical or photochemical imitation sources for the in situ polymerization of the oligomers and polymer precursors described herein. It is to be understood that other variations are also contemplated.

1. An oligomer comprising
(a) a polyester formed from a plurality of hydroxyacids, where the polyester terminates in one or more hydroxyl groups; and
(b) one or more unsaturated carboxylic acids, where at least one of the unsaturated carboxylic acids forms an ester with at least one of the hydroxyl groups.

2. The oligomer of claim 1 wherein each hydroxyacid is independently selected, and is a compound of the formula 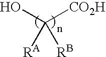
wherein n is an integer from 1 to about 11, and R^{A} and R^{B} are each independently selected from the group consisting of hydrogen, halo, alkyl, and alkoxy.

3. The oligomer of claim 1 wherein each hydroxyacid is independently selected from the group consisting of glycolic acid, glycolide, lactic acid, lactide, β-lactone, δ-butyrolactone, γ-valerolactone, ε-caprolactone, and 6-hydroxycaproic acid.

4. The oligomer of claim 1 wherein each unsaturated carboxylic acids is independently selected, and is a compound of the formula 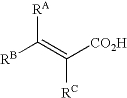
wherein R^{A}, R^{B}, and R^{B} are each independently selected from the group consisting of hydrogen, halo, alkyl, and alkoxy.

5. The oligomer of claim 1 wherein each unsaturated carboxylic acid is independently selected from the group consisting of acrylic acid, crotonic acid, and methacrylic acid, each of which may be optionally substituted.

6.-8. (canceled)

9. The oligomer of claim 1 wherein the polyester is a copolymer of glycolic acid and lactic acid.

10.-12. (canceled)

13. The oligomer of claim 1 further comprising one or more multifunctional core monomers.

14. (canceled)

15. The oligomer of claim 12 wherein at least one of the multifunctional core monomers is a polyol.

16. The oligomer of claim 13 wherein the multifunctional core monomer is selected from the group consisting of glycerol, trimethylolethane, trimethylolpropane, pentaerythritol, dipentaerythritol, tripentaerythritol, and mixtures thereof.

17.-18. (canceled)

19. The oligomer of claim 1 where the ratio of monomer to core molecule is in the range from about 5:1 to about 30:1.

20. The oligomer of claim 1 where the ratio of monomer to core molecule is in the range from about 5:1 to about 20:1.

21. The oligomer of claim 1 where the ratio of monomer to core molecule is in the range from about 5:1 to about 12:1.

22. The oligomer of claim 1 having a weight average molecular weight in the range from about 200 to about 40,000.

23. The oligomer of claim 1 having a number average molecular weight in the range from about 100 to about 15,000.

24. The oligomer of claim 1 having a number average molecular weight in the range from about 300 to about 500.

25.-27. (canceled)

28. A composition comprising a mixture of (a) an oligomer of claim 1; and (b) one or more fillers.

29. The composition of claim 28 wherein at least one of said fillers is a calcium phosphate salt.

30.-33. (canceled)

34. A tissue implant formed by curing a composition of claim 28.

35.-39. (canceled)

40. A method for repairing a tissue injury or tissue defect, the method comprising the steps of (a) introducing a composition of claim 28 to the injury or the defect; and (b) curing the composition to form an implant.

41. (canceled)

42. The method of claim 40 wherein the tissue injury or tissue defect is periodontal defect.
